(19) United States
(12) Patent Application Publication
(10) Pub. No.: US 2008/0008953 A1
(43) Pub. Date: Jan. 10, 2008

(54) Liquid Developer And Image Forming Apparatus Using The Same

(75) Inventors: Nobuhiro MIYAKAWA, Ashiya-shi (JP); Shinji YASUKAWA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/768,859

(22) Filed: Jun. 26, 2007

(30) Foreign Application Priority Data
Jul. 7, 2006 (JP) 2006-188210
Jul. 7, 2006 (JP) 2006-188211
Mar. 8, 2007 (JP) 2007-058613

(51) Int. Cl. G03G 9/00; G03G 15/00

(52) U.S. Cl. 430/116; 399/159

(57) ABSTRACT

A liquid developer includes a vegetable oil as a carrier liquid, a positively chargeable pigment and an antioxidant including a trialkyl phosphite represented by the chemical formula 1 and/or a diphenyl alkyl phosphite represented by the chemical formula 2:

(CₘH₂ₘ₊₁O)₃PChemical formula 1
wherein m is 2 to 20,

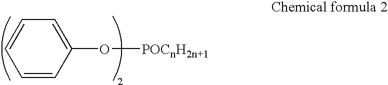

wherein n is 5 to 15.

The entire disclosure of Japanese Patent Application Nos: 2006-188210, filed Jul. 7, 2006 and 2006-188211, filed Jul. 7, 2006 and 2007-58613, filed Mar. 8, 2007 are expressly incorporated by reference herein.

### BACKGROUND

1. Technical Field

The present invention relates to a liquid developer to be used in an image forming apparatus using an electrophotographic system, for example, a copying machine, a printer or the like, and an image forming apparatus using the same.

2. Related Art

An image forming apparatus which uses a liquid developer can form a high-resolution image without causing dispersion of toner particles contained in the liquid developer outside the apparatus even if the toner particles are fine. The liquid developer is a developer in which toner particles containing a colorant and a resin as main components are dispersed in a carrier liquid. An image forming apparatus using an electrophotographic system and using a liquid developer develops an electrostatic latent image formed on a photoreceptor by exposure to light with a liquid developer and then transfers and fixes an obtained toner image to a recording medium such as paper.

Heretofore, a volatile petroleum hydrocarbon solvent has been used as a carrier liquid for a liquid developer. It was necessary to volatilize or evaporate a volatile hydrocarbon organic solvent when fixing transferred or recorded toner particles to a recording medium, however, the discharge of the volatile hydrocarbon organic solvent could cause environmental pollution.

Therefore, it was necessary to provide a unit which collects such an evaporated or volatilized volatile hydrocarbon organic solvent near a fixing device. However, because of the unit which collects the volatile hydrocarbon organic solvent, the image forming apparatus had to increase in size.

Thus, as a carrier liquid for a liquid developer, the use of nonvolatile silicone oil or liquid paraffin has been proposed. Because silicone oil and liquid paraffin are stable, they stay on the recording medium even after the fixation. As a result, problems such as deterioration of print quality, decrease in imprint performance due to the presence of the carrier liquid on the surface of recording medium, and decrease in writing performance of writing materials in which an aqueous ink is used arose.

When a related liquid developer is produced, each component is dispersed in a non-aqueous non-polar solvent which is a carrier liquid. Problems such as increase in size of apparatus, deterioration of the quality of the recorded matter and decrease in storage stability of liquid developer were caused by the properties of the non-polar solvent.

On the other hand, the use of a vegetable oil as a carrier liquid instead of the volatile hydrocarbon organic solvent has been proposed. For example, in JP-A-2000-19787, the particle size of toner particles contained in a liquid developer in which a vegetable oil is used as a carrier liquid is small, the liquid developer is odorless, and the image density, resolution and fixing property of an image formed by using the liquid developer are high. However, it is inevitable to use a charge controlling agent for allowing a colorant dispersed in the vegetable oil to have a positive charge. Therefore, when the used amount of the charge controlling agent is increased, the storage stability of the liquid developer becomes unstable. In particular, when a liquid metal soap was used as the charge controlling agent, the viscosity of the liquid developer increased during a long-term storage, and the developer did not function as a liquid developer. Further, the positive charge stability of a colorant contained in a liquid developer in which a vegetable oil is used as a carrier liquid has not been investigated.

### SUMMARY

An advantage of some aspects of the invention is to provide a liquid developer which contains a vegetable oil as a carrier liquid and is excellent in storage stability and positive charge stability, and an image forming apparatus using the liquid developer.

A first aspect of the invention is a liquid developer including a vegetable oil as a carrier liquid, a positively chargeable pigment and an antioxidant including a trialkyl phosphite represented by the chemical formula 1 and/or a diphenyl alkyl phosphite represented by the chemical formula 2:

(CₘH₂ₘ₊₁O)₃P Chemical formula 1
wherein m is 2 to 20;

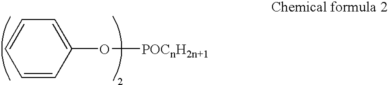

wherein n is 5 to 15.

The liquid developer according to the aspect of the invention has excellent storage stability and positive charge stability.

In a preferred embodiment of the invention, the vegetable oil contained in the liquid developer includes at least one member selected from the group consisting of flaxseed oil, MO sunflower oil, rapeseed oil, divider oil, HOLL canola, thistle saffron oil, olive oil, peanut oil, sesame oil, corn oil, soybean oil, cotton seed oil and safflower oil.

In another preferred embodiment of the invention, the trialkyl phosphite and/or the diphenyl alkyl phosphite contained in the liquid developer are/is soluble in the vegetable oil. By the dissolution of the trialkyl phosphite and/or the diphenyl alkyl phosphite in the vegetable oil, the function to keep the positive chargeability of the colorant is improved.

In a still another preferred embodiment of the invention, the added amount of the trialkyl phosphite and/or the diphenyl alkyl phosphite contained in the liquid developer is 0.01 to 5.0% by mass based on the total amount of the vegetable oil and the positively chargeable pigment. A liquid developer in which the added amount the trialkyl phosphite and/or the diphenyl alkyl phosphite exceeds 5.0% by mass based on the total amount of the vegetable oil and the positively chargeable pigment forms an image with a low fixing ratio.

In a still another preferred embodiment of the invention, the trialkyl phosphite contained in the liquid developer is triethylphosphite, tris(2-ethylhexyl)phosphite, tridecyl phosphite, trilauryl phosphite or tris(tridecyl)phosphite.

In a still another preferred embodiment of the invention, the diphenyl alkyl phosphite contained in the liquid developer includes at least one member selected from the group consisting of diphenyl mono(2-ethylhexyl)phosphite, diphenyl monodecyl phosphite and diphenyl mono(tridecyl)phosphite.

A second aspect of the invention is an image forming apparatus which uses a liquid developer including a vegetable oil as a carrier liquid, a positively chargeable pigment and an antioxidant including a trialkyl phosphite represented by the chemical formula 1 and/or a diphenyl alkyl phosphite represented by the chemical formula 2:

(CₘH₂ₘ₊₁O)₃P Chemical formula 1
wherein m is 2 to 20;

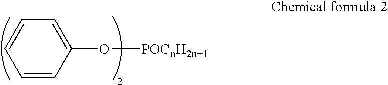

wherein n is 5 to 15.

In a preferred embodiment of the invention, the image forming apparatus includes a photoreceptor on which an electrostatic latent image is formed and a transfer unit, wherein the electrostatic latent image on the photoreceptor is transferred to a recording medium passing through between the photoreceptor and the transfer unit.

In another preferred embodiment of the invention, the image forming apparatus includes a photoreceptor on which an electrostatic latent image is formed, an intermediate transfer unit, which is an endless belt supported in a tensioned state by rollers, and a secondary transfer unit which secondarily transfers an image on the intermediate transfer unit, which is formed by primarily transferring an electrostatic latent image on the photoreceptor to the intermediate transfer unit from the photoreceptor, to a recording medium.

### BRIEF DESCRIPTION OF THE DRAWINGS

The invention will be described with reference to the accompanying drawings, wherein like numbers reference like elements.

FIG. 1A illustrates a measurement cell for the chargeability of a pigment dispersed in a vegetable oil.

FIG. 1B illustrates a measurement cell for the chargeability of a pigment dispersed in a vegetable oil.

FIG. 2 illustrates an image forming apparatus using a liquid development system.

FIG. 3 illustrates an image forming apparatus using a liquid development system.

### DESCRIPTION OF EXEMPLARY EMBODIMENTS

Specific examples of the vegetable oil to be used as a carrier liquid for a liquid developer according to an embodiment of the invention include flaxseed oil, MO sunflower oil, rapeseed oil, divider oil, HOLL canola, thistle saffron oil, olive oil, peanut oil, sesame oil, corn oil, soybean oil, cotton seed oil and safflower oil. One type of vegetable oil or a mixture of several types of vegetable oils is used as a carrier liquid.

A triglyceride having a composition of fatty acids in which the content of unsaturated bonds is high such as oleic acid, linoleic acid and linolenic acid is susceptible to oxidative polymerization. Therefore, in an image forming apparatus using a liquid developer in which such a triglyceride is used as a carrier liquid, a fixing unit is not needed or it can be simplified.

Examples of the composition of triglyceride in the vegetable oil to be used as a carrier liquid for the liquid developer according to the embodiment of the invention are shown in Table 1. In Table 1, the ratio of each fatty acid to the total fatty acids is represented by % by mass.

TABLE 1

| | Palmitic | Stearic | Oleic | Linoleic | Linolenic |
|---|---|---|---|---|---|
| Fatty acid | acid | acid | acid | acid | acid |
| Flaxseed oil | 5.3% | 3.2% | 20.2% | 15.1% | 56.2% |
| MO sunflower oil | 3.6% | 3.6% | 60.5% | 29.7% | 0.3% |
| Rapeseed oil | 4.1% | 1.9% | 62.7% | 19.7% | 8.8% |
| Divider oil | 4.0% | 2.1% | 72.2% | 16.2% | 4.3% |
| HOLL canola | 4.2% | 2.6% | 73.7% | 12.2% | 3.9% |
| Thistle saffron oil | 4.8% | 1.9% | 76.9% | 14.9% | 0.2% |
| Olive oil | 10.3% | 2.9% | 78.8% | 5.9% | 0.6% |
| Peanut oil | 11.0% | 3.4% | 47.1% | 30.7% | 0.8% |
| Sesame oil | 9.1% | 5.5% | 38.2% | 44.5% | 0.3% |
| Corn oil | 11.3% | 1.9% | 32.2% | 52.2% | 1.0% |
| Soybean oil | 10.6% | 4.4% | 23.3% | 53.4% | 7.0% |
| Cotton seed oil | 19.8% | 2.4% | 19.3% | 55.7% | 0.8% |
| Safflower oil | 6.4% | 2.2% | 13.9% | 76.0% | 0.2% |

A charge controlling agent and a resin can be blended in the liquid developer according to the embodiment of the invention together with a pigment.

Specific examples of the charge controlling agent include titanium chelates such as tetraethyl titanate, tetraisopropyl titanate, tetra-n-propyl titanate, tetra-n-butyl titanate, tetra-tert-butyl titanate, tetra-2-ethylhexyl titanate, tetraoctyl titanate, tetramethoxy titanium and titanyl acetylacetonate and titanium coupling agents.

Specific examples of the titanium coupling agent include isopropyl triisostealoyl titanate, isopropyl tridecyl benzenesulfonyl titanate, isopropyltris (dioctylpyrophosphate) titanate, tetraisopropylbis (dioctylphosphite) titanate, tetraoctylbis (ditridecylphosphite) titanate, tetra(2,2-diallyloxymethyl-1-butyl)bis-(di-tridecyl)phosphite titanate, bis(dioctylpyrophosphate)ethylene titanate, isopropyl trioctanoyl titanate, isopropyl dimethacryl isostearoyl titanate, isopropyl isostearoyl diacryl titanate, isopropyltri(dioctylphosphate) titanate, isopropyl tricumylphenyl titanate and isopropyltri(N-aminoethyl-aminoethyl)titanate.

Specific examples of the resin include ethylene-vinyl acetate copolymers, polyester resins, styrene-acrylic resins, rosin-modified resins, polyethylene, ethylene-acrylic acid copolymers, ethylene-maleic anhydride copolymers, polyvinylpyridine, polyvinylpyrrolidone, ethylene-methacrylic acid copolymers and ethylene-acrylic acid ester copolymers. One type of resin or a combination of two or more types of resins is used.

A vegetable oil, a pigment, an antioxidant and the like are mixed, and dispersion is carried out using a dispersing device such as an attritor, a sand mill, a ball mill or a vibrating mill, whereby the liquid developer according to the embodiment of the invention can be obtained.

The primary particle size of colored fine particles contained in the liquid developer according to the embodiment of the invention is preferably 1 μm or less as a number average particle size.

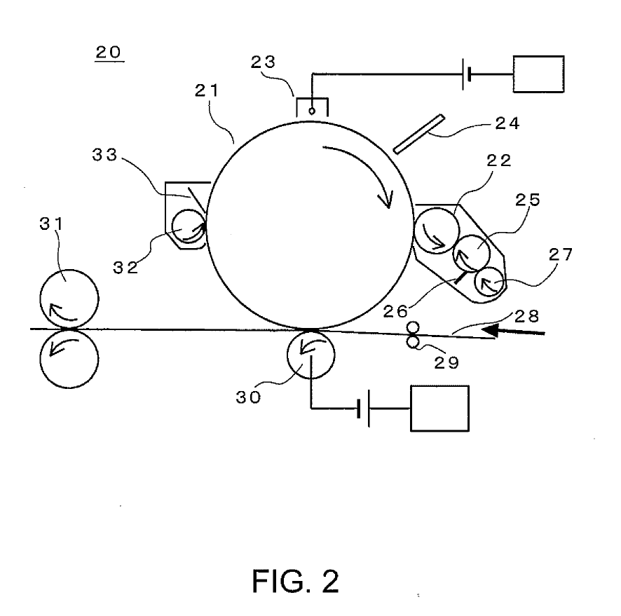

FIG. 2 shows an embodiment of the image forming apparatus according to the embodiment of the invention. The surface of a photoreceptor 21 of an image forming apparatus 20 is charged with a scorotron 23, and laser beams are irradiated from a laser beam irradiation unit 24 under control of an image signal, whereby an electrostatic latent image is formed.

Then, a developing bias is applied to a developing roller 22, whereby development is effected. A liquid developer in which the layer thickness thereof is regulated by a regulating blade 26 is supplied to the developing roller 22 while an anilox roller 25 in contact with the developing roller 22 is rotating.

Further, the liquid developer is supplied to the anilox roller 25 from a supply roller 27. A recording medium 28 is fed by a feed roller pair 29 in the arrow direction.

A transfer bias is applied to a transfer roller 30 through a control system. An image transferred to the recording medium passes through between a heat fixing roller pair 31, and fixed on the recording medium.

In the case where transfer residual toner remains, an elastic cleaning roller 32 in contact with the photoreceptor allows the liquid developer to move from the photoreceptor and the liquid developer is removed by a cleaning blade 33 located in an upper portion of the cleaning roller. The cleaned photoreceptor is subjected to a cycle of charging, exposure, development, transfer and cleaning again, and a single color image is formed.

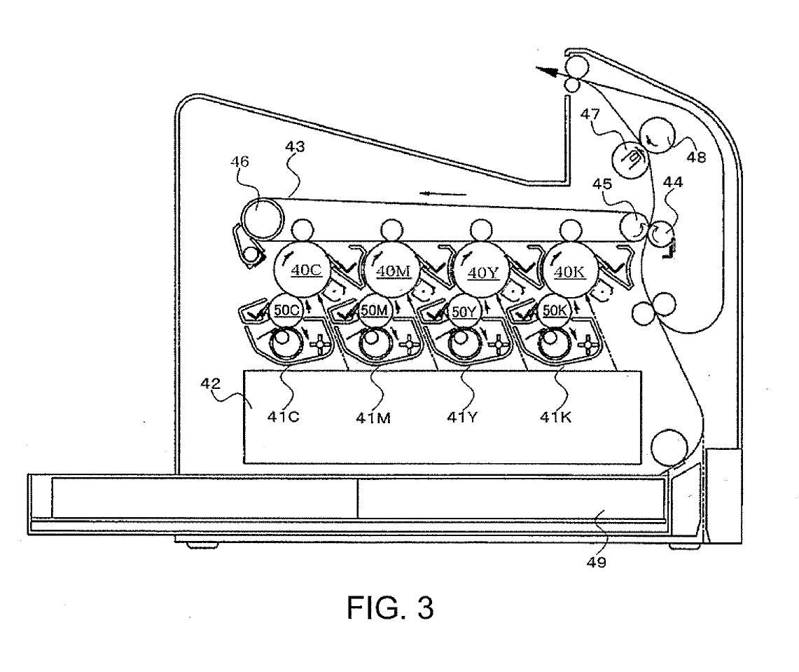

FIG. 3 shows a tandem printer using a liquid development system which is another embodiment of the image forming apparatus according to the embodiment of the invention. A cyan pigment (C), a magenta pigment (M), a yellow pigment (Y) and a black pigment (K) are stored in developing containers 41C, 41M, 41Y and 41K, respectively. Based on an inputted image signal, laser beams modulated by an exposure unit 42 are irradiated on the uniformly charged photoreceptors 40C, 40M, 40Y and 40K, respectively, and electrostatic latent images are formed on the photoreceptors 40C, 40M, 40Y and 40K, respectively.

Then, the electrostatic latent images formed on the photoreceptors 40C, 40M, 40Y and 40K are developed by the liquid developers of the respective colors stored in the developing containers 41C, 41M, 41Y and 41K. The developed toner images of the respective colors on the photoreceptors 40C, 40M, 40Y and 40K are primarily transferred to an intermediate transfer belt 43 sequentially.

The intermediate transfer belt 43 is an endless belt, and is supported in a tensioned state between a belt drive roller 45 and a tension roller 46, and rotatably driven by the drive roller 45 while being in contact with the photoreceptors 40C, 40M, 40Y and 40K. The toner image formed on the intermediate transfer belt 43 is secondarily transferred to a recording medium fed from a cassette 49 at a secondary transfer position at which a secondary transfer roller 44 is located.

The recording medium passing through the secondary transfer position is pressed against a fixing roller 47 by a pressure roller 48, whereby the toner image on the recording medium is fixed.

### EXAMPLES

Hereinafter, the invention will be specifically described with reference to Examples, however, the invention is not limited to these.

### Example 1 and Comparative Examples 1 and 2

320 g of zirconia balls with a diameter of 5 mm, 100 g of oleic acid (manufactured by Kanto Kagaku Co.), 0.23 g of a dispersing agent (AJISPER PB822, manufactured by Ajinomoto Fine Techno Co. Inc.), 15 g of Pigment Blue 15:3 (positively chargeable cyan pigment) and 4 g of an antioxidant shown in Table 2 were introduced into a stainless steel vessel with a capacity of 500 ml, and mixed by dispersion with a commercially available stirrer, Tornado SM-type propeller stirring blade at a rotation speed of 504 rpm for 11 hours, whereby a colorant dispersion was prepared.

Then, 5 g of the resulting colorant dispersion was added to 30 g of flaxseed oil (manufactured by Nisshin Oillio Group, Ltd., the content of linolenic acid based on the total fatty acids in triglyceride is 56.2% by mass), which is a carrier liquid, and the mixture was well mixed, whereby a liquid developer was obtained. A liquid developer to which an antioxidant was not added was also prepared as a blank.

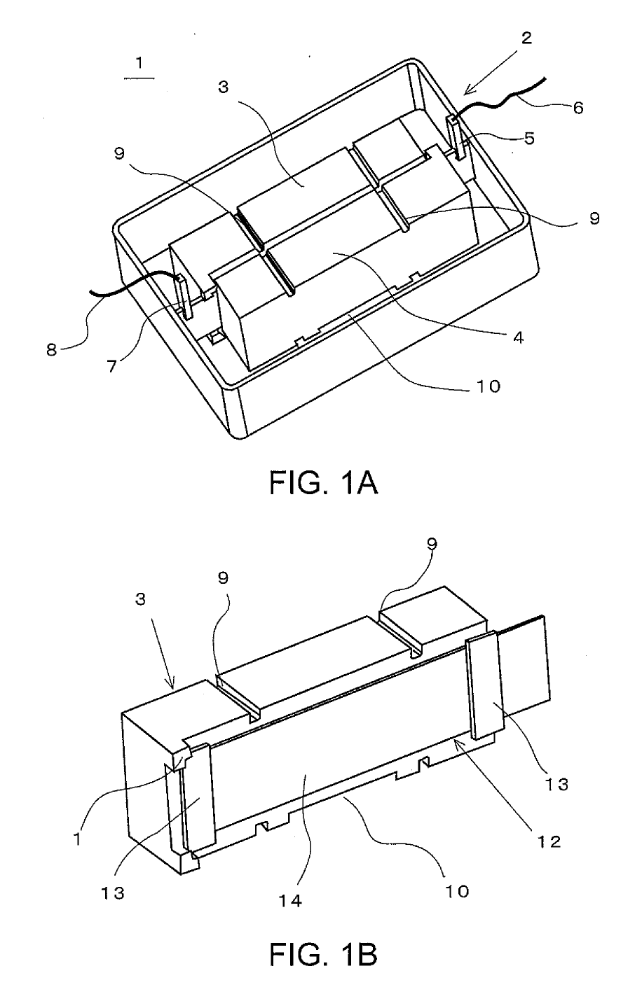

Then, the charging behavior of each colorant dispersion at room temperature of 25° C. was examined with an electrophoresis experimental apparatus shown in FIGS. 1A and 1B. FIG. 1A is a perspective view showing a measurement cell, and FIG. 1B is a perspective view illustrating an electrode section.

A measurement cell 1 has a structure in which an anode side electrode section 3 and a cathode side electrode section 4 are installed in a container 2 made of an electrically insulating material such as glass or a synthetic resin. An anode side lead wire 6 for power supply connected to a current supply device (not shown) is connected to an anode terminal provided at the anode side electrode section 3, and a cathode side lead wire 8 connected to the current supply device (not shown) is connected to a cathode terminal 7 provided at the cathode side electrode section 4.

The anode side electrode section 3 and the cathode side electrode section 4 have grooves 9 for mounting a support member for supporting both electrode sections spaced a predetermined distance from each other on an upper portion thereof, and the space between the anode side electrode section 3 and the cathode side electrode section 4 during the measurement is kept by the support member. A passage groove 10 is provided at a lower portion of the anode side electrode section 3 and the cathode side electrode section 4 for supplying the colorant dispersion smoothly.

The anode electrode section is shown in FIG. 1B, however, the cathode electrode section is also formed to have the same structure and members. The anode electrode section 3 is made of a resin with high oil resistance and solvent resistance such as a polyacetal resin (POM), and is a molded article provided with an anode engaging protrusion 11.

An anode 12 is attached to the anode engaging protrusion 11 along with a spacer 13 made of an electrically insulating material for keeping the space with the counter electrode constant. Preferably, a transparent conductive film 14 made of ITO or the like which is not eluted by an applied current is formed on a transparent glass plate of the anode 12.

The anode in which the transparent conductive film is formed on the transparent glass plate is removed from the anode electrode section after completion of the electrophoresis by applying current for a predetermined period of time, and optical observation and measurement of the colorant deposited on the anode can be easily carried out.

A direct current voltage of 300 V was applied to the electrophoresis experimental apparatus for 10 seconds, and electrophoresed colored fine particles were attached to the transparent electrode made of ITO. The transparent electrode was removed from the measurement cell, and the colored fine particles attached to the electrode were transferred by pressure onto a transfer paper (J paper, manufactured by Fuji Xerox Office Supply Co. Ltd.), whereby the colored fine particles attached to the respective electrodes were obtained as a colored solid image on the transfer paper.

After the resulting colored solid image was left stand for 1 day, the density of the colored solid image was measured using a reflection densitometer (model 520 spectro densitometer, manufactured by X-Rite Inc.) as a reflection density. Based on the amount of colored fine particles attached to the electrode, that is, the value of reflection density on the transfer paper, it is determined whether the colored fine particles are charged positively, negatively or neutrally (it means that the attached amounts of positively charged particles and negatively charged particles are equal).

The values of reflection density of the solid images transferred to the transfer papers from the respective anode and cathode were obtained and the difference between them was obtained as an image contrast [(OD value of positively charged toner attached to the cathode)−(OD value of negatively charged toner attached to the anode)]. Then, based on the resulting value, the chargeability of positively chargeable toner was determined.

The measurement results are shown in Table 2.

TABLE 2

| | Antioxidant | Image contrast |
|---|---|---|
| Blank | | 0.66 |
| Example 1-1 | Triethyl phosphite | 0.87 |
| Example 1-2 | Diphenyl mono(2-ethylhexyl) phosphite | 0.88 |
| Comparative | Dibutylhydroxy toluene | 0.56 |
| example 1 | | |
| Comparative | Distearylpentaerythritol diphosphite | 0.65 |
| example 2 | | |

The liquid developer to which triethyl phosphite or diphenyl mono(2-ethylhexyl)phosphite was added showed a higher image contrast value than the liquid developer to which an antioxidant was not added.

The liquid developer to which a phenol antioxidant, dibutylhydroxy toluene was added and the liquid developer to which a phosphite antioxidant, distearylpentaerythritol diphosphite was added showed a lower image contrast value than the liquid developer to which an antioxidant was not added.

The physical properties of the antioxidants used are shown in Table 3.

TABLE 3

| | Molecular | | Melting point | Solubility in |
|---|---|---|---|---|
| | weight | Appearance | (° C.) | flaxseed oil |
| Example 1-1 | 166 | Transparent | — | Very soluble |
| | | liquid | | |
| Example 1-2 | 374 | Transparent | — | Very soluble |
| | | liquid | | |
| Comparative | 732 | Colorless | 65 | Insoluble |
| example 1 | | crystal | | |
| Comparative | 732 | White solid | 40 or higher | Insoluble |
| example 2 | | | | |

It can be presumed that as a result of dissolving an antioxidant in flaxseed oil as a carrier and improving the function to keep the charge of the colorant positive, the function as the positively chargeable liquid developer is improved. Thus, it is considered that the dissolution of an antioxidant in a carrier is essential not to inhibit the positively chargeable function.

### Example 2

As in the same manner as in Example 1, soybean oil (manufactured by Nisshin Oillio Group, Ltd., the content of linoleic acid based on the total fatty acids in triglyceride is 53.4% by mass) was used as a carrier liquid, and a trialkyl phosphite or a diphenyl alkyl phosphite shown in Table 4 was added such that the added amount thereof based on the total amount of a carrier liquid and a colorant in a liquid developer becomes 0.5% by mass, whereby a liquid developer for evaluation was prepared and an image contrast was obtained.

A liquid developer to which an antioxidant was not added was also prepared and used as a blank.

The results are shown in Table 4. Further, the results of odor evaluation test by sensory evaluation described below are also shown in Table 4.

TABLE 4

| | | Image | |
|---|---|---|---|
| | Antioxidant | contrast | Odor evaluation test |
| Blank | | 0.69 | A little good (1.2) |
| Example 2-1 | Tris(2-ethylhexyl) | 0.79 | Extremely good (0.2) |
| | phosphite | | |
| Example 2-2 | Tridecyl phosphite | 0.75 | Extremely good (0.2) |
| Example 2-3 | Trilauryl phosphite | 0.74 | Extremely good (0.2) |
| Example 2-4 | Tris(tridecyl) phosphite | 0.73 | Extremely good (0.2) |
| Example 2-5 | Diphenyl monodecyl | 0.79 | Extremely good (0.2) |
| | phosphite | | |
| Example 2-6 | Diphenyl mono(tridecyl) | 0.75 | Extremely good (0.2) |
| | phosphite | | |

The liquid developer according to the embodiment of the invention, to which a trialkyl phosphite or a diphenyl alkyl phosphite which is soluble in soybean oil as a carrier liquid was added, showed a higher image contrast value than the liquid developer in which a trialkyl phosphite or a diphenyl alkyl phosphate was not added to soybean oil.

After each liquid developer was stored for 6 months, an odor thereof was evaluated by sensory evaluation described below.

The liquid developer to which a trialkyl phosphite or a diphenyl alkyl phosphite was not added had an odor specific to soybean oil. On the other hand, the liquid developer to which a trialkyl phosphite or a diphenyl alkyl phosphite was added had almost no odor and was stable in terms of its composition.

### Odor Evaluation Test by Sensory Evaluation

A transparent glass container in which a liquid developer was contained was sealed and stored under stationary conditions at 40° C. for 6 months. The odor of the liquid developer after 6 months was compared with that of a freshly prepared liquid developer with the same composition and evaluation was carried out by 10 examiners by way of sensory evaluation as follows.

First, the odor of each liquid developer was evaluated by 10 examiners and given a score of 0 to 3.

### 0: There was no change.

### 1: There was a little change.

### 2: There was an apparent change.

### 3: It completely changed and there was a strong odor.

An average of the scores obtained for each liquid developer was calculated, and the odor of each liquid developer was determined based on the following evaluation criteria.

Very good: An average value is 0.3 or less.

### Good: An average value is in the range of 0.3 to 1.0.

A little good: An average value is in the range of 1.0 to 2.0.
Not good: An average value is in the range of 2.1 to 3.0.

### Example 3

320 g of zirconia balls with a diameter of 5 mm, 100 g of oleic acid (manufactured by Kanto Kagaku Co.), 0.23 g of a dispersing agent (AJISPER PB822, manufactured by Ajinomoto Fine Techno Co. Inc.) and 15 g of Pigment Red 57:1 (positively chargeable magenta pigment) were introduced into a stainless steel vessel with a capacity of 500 ml, and mixed by dispersion with a commercially available stirrer, Tornado SM-type propeller stirring blade at a rotation speed of 504 rpm for 11 hours, whereby a colorant dispersion was prepared.

Then, 5 g of the resulting colorant dispersion was added to 30 g of safflower oil (manufactured by Nisshin Oillio Group, Ltd., the content of linoleic acid based on the total fatty acids in triglyceride is 76.0% by mass), which is a carrier liquid, and the mixture was well mixed, whereby a liquid developer was obtained.

Then, a phosphite antioxidant, tris(2-ethylhexyl)phosphite was added thereto in an amount shown in Table 5, that is, in an amount such that the added amount of tris(2-ethylhexyl)phosphite based on the total amount of a carrier liquid and a colorant in a liquid developer becomes 0%, 0.01%, 0.1%, 0.3%, 0.5%, 2.0% or 5.0% by mass, and the mixture was well mixed, whereby a liquid developer for evaluation was prepared. An image contrast was obtained in the same manner as in Example 1. The results are shown in Table 5.

### Image Evaluation Test with Image Forming Apparatus Using Liquid Development System

In accordance with the procedure in Example 1, 250 g of a liquid developer was prepared, and development, transfer, cleaning and fixing were carried out with an image forming apparatus using a liquid development system shown in FIG. 2. A single-layered positively charged organic photoreceptor is used as a photoreceptor 21 of an image forming apparatus 20 and a developing roller 22 is made of an elastic material. First, the surface of the photoreceptor 21 is charged to +650 V with a scorotron 23, and laser beams are irradiated from a laser beam irradiation unit 24 under control of an image signal, whereby an electrostatic latent image is formed.

Then, a developing bias of +300 V is applied to a developing roller 22, whereby development is effected. A liquid developer in which the layer thickness thereof is regulated by a regulating blade 26 is supplied to the developing roller 22 while an anilox roller 25 in contact with the developing roller 22 is rotating. Further, the liquid developer is supplied to the anilox roller 25 from a supply roller 27, which is a sponge-like elastic roller. A transfer bias is −950 V, and a recording medium 28 is fed by a feed roller pair 29 in the arrow direction at a rate of 200 mm/sec.

A transfer roller 30 is an elastic roller and the transfer bias is applied to the transfer roller through a control system. An image transferred to the recording medium passes through between a heat fixing roller pair 31 made of an oil-repellent material, and fixed on the recording medium. The fixing temperature is set to 90° C., and a developed and transferred toner image is no longer transferred upon contact with the other members.

In the case where transfer residual toner remains, an elastic cleaning roller 32 in contact with the photoreceptor allows the liquid developer to move from the photoreceptor and the liquid developer is removed by a cleaning blade 33 located in an upper portion of the cleaning roller. The cleaned photoreceptor is subjected to a cycle of charging, exposure, development, transfer and cleaning again, and a single color image is formed.

By using each liquid developer, a paper with 5% page coverage (a 2 cm square solid area was provided therein) was printed and outputted. Mending tape (12 mm width) manufactured by Sumitomo 3M Co., Ltd. was adhered to a printed image formed on a transfer paper (J paper, manufactured by Fuji Xerox Office Supply Co. Ltd.), and a load of 500 g was applied to the tape 10 times. Then, the tape was peeled, and the density of the printed image remaining on the transfer paper was measured. The fixing ratio was represented by a percentage of the density of the printed image remaining on the transfer paper to the density of the printed image before the tape was peeled, and evaluation of the fixing ratio was carried out.

The results are shown in Table 5. The reflection density of the printed image was measured using the above-mentioned commercially available reflection densitometer (manufactured by X-Rite Inc.).

TABLE 5

| | | | Fixing |
|---|---|---|---|
| | Added amount of antioxidant | Image contrast | ratio |
| Blank | 0 | 0.73 | 84% |
| Example 3-1 | 0.01% by mass | 0.80 | 84% |
| Example 3-2 | 0.1% by mass | 0.86 | 84% |
| Example 3-3 | 0.3% by mass | 0.90 | 83% |
| Example 3-4 | 0.5% by mass | 0.92 | 83% |
| Example 3-5 | 2.0% by mass | 0.84 | 82% |
| Example 3-6 | 5.0% by mass | 0.83 | 81% |

As the added amount of tris(2-ethylhexyl)phosphite was increased, the image contrast firstly increased gradually and thereafter decreased. The fixing ratio gradually decreased as the added amount of tris(2-ethylhexyl)phosphite was increased. From the results, it was found that the addition of a trialkyl phosphite in an amount exceeding 5% by mass lowers the fixing ratio to an unfavorable extent.

### Example 4

The same procedure as in Example 3 was carried out except that diphenyl mono(tridecyl)phosphite was used instead of tris(2-ethylhexyl)phosphite used in Example 3, and an image contrast and a fixing ratio were measured.

The results are shown in Table 6.

TABLE 6

| | | | Fixing |
|---|---|---|---|
| | Added amount of antioxidant | Image contrast | ratio |
| Blank | 0 | 0.73 | 84% |
| Example 4-1 | 0.01% by mass | 0.82 | 84% |
| Example 4-2 | 0.1% by mass | 0.88 | 84% |
| Example 4-3 | 0.3% by mass | 0.91 | 83% |
| Example 4-4 | 0.5% by mass | 0.93 | 83% |
| Example 4-5 | 2.0% by mass | 0.86 | 82% |
| Example 4-6 | 5.0% by mass | 0.85 | 81% |

As the added amount of diphenyl mono(tridecyl)phosphite was increased, the image contrast firstly increased gradually and thereafter decreased. The fixing ratio gradually decreased as the added amount of diphenyl mono(tridecyl)phosphite was increased. From the results, it was found that the addition of a diphenyl alkyl phosphite in an amount exceeding 5% by mass lowers the fixing ratio to an unfavorable extent.

### Example 5

320 g of zirconia balls with a diameter of 5 mm, 100 g of oleic acid (manufactured by Kanto Kagaku Co.), 15 g of benzimidazolon pigment P.R. 185 (positively chargeable pigment) and 0.23 g of a dispersing agent (AJISPER PB822, manufactured by Ajinomoto Fine Techno Co. Inc.) were introduced into a stainless steel vessel with a capacity of 500 ml, and mixed by dispersion with a commercially available stirrer, Tornado SM-type propeller stirring blade at a rotation speed of 504 rpm for 14 hours, whereby a colorant dispersion was prepared.

Then, 5 g of the resulting colorant dispersion and 0.175 g of a phosphite antioxidant, tridecyl phosphite were added to 30 g of each of the vegetable oils shown in Table 7, and the mixture was well mixed, whereby 9 types of liquid developers were obtained. Then, the charging behavior of each liquid developer at room temperature of 25° C. was examined with an electrophoresis experimental apparatus shown in FIGS. 1A and 1B in the same manner as in Example 1, and an obtained image contrast is shown in Table 7.

Further, evaluation of fixing property was carried out in an image evaluation test by the above-mentioned image forming apparatus using a liquid development system. The results are also shown in Table 7 as a fixing ratio.

TABLE 7

| | Vegetable oil | Image contrast | Fixing ratio |
|---|---|---|---|
| Example 5-1 | MO sunflower oil | 0.92 | 82% |
| Example 5-2 | Rapeseed oil | 0.93 | 82% |
| Example 5-3 | Divider oil | 0.93 | 81% |
| Example 5-4 | HOLL canola | 0.94 | 80% |
| Example 5-5 | Thistle saffron oil | 0.94 | 80% |
| Example 5-6 | Olive oil | 0.94 | 80% |
| Example 5-7 | Peanut oil | 0.92 | 82% |
| Example 5-8 | Corn oil | 0.92 | 83% |
| Example 5-9 | Cotton seed oil | 0.92 | 83% |

### Example 6

The same procedure as in Example 5 was carried out except that diphenyl monodecyl phosphite was used instead of tridecyl phosphite used in Example 5, and an image contrast and a fixing ratio were measured.

The results are shown in Table 8.

TABLE 8

| | Vegetable oil | Image contrast | Fixing ratio |
|---|---|---|---|
| Example 6-1 | MO sunflower oil | 0.94 | 81% |
| Example 6-2 | Rapeseed oil | 0.94 | 82% |
| Example 6-3 | Divider oil | 0.95 | 81% |
| Example 6-4 | HOLL canola | 0.94 | 80% |
| Example 6-5 | Thistle saffron oil | 0.93 | 80% |
| Example 6-6 | Olive oil | 0.94 | 81% |
| Example 6-7 | Peanut oil | 0.95 | 81% |
| Example 6-8 | Corn oil | 0.95 | 81% |
| Example 6-9 | Cotton seed oil | 0.93 | 82% |

From the results of Examples 5 and 6, there was a tendency that when a liquid developer containing as a carrier liquid, a vegetable oil in which the content of oleic acid in triglyceride is high is used, an image contrast becomes relatively high. The fixing ratio was about 81%, and a significant difference was not observed.

### Example 7

50 g of the colorant dispersion obtained in Example 3 was dispersed in 150 g of corn oil (manufactured by Nisshin Oillio Group, Ltd.) together with 0.875 g of trilauryl phosphite (a transparent liquid, molecular weight: 586), which is an antioxidant, whereby a liquid developer was prepared. Then, development, transfer, fixing and cleaning were carried out with an image forming apparatus using a liquid development system shown in FIG. 2. The image forming procedure was in accordance with the procedure in Example 3. Changes in the image quality and fixing property of the printed and outputted paper with 5% page coverage obtained by this image forming apparatus were evaluated over time. The results are shown in Table 9.

An initially printed image was stored in a laboratory. After 6 months, the fixing ratio in a solid area was measured again, and the fixing ratio in the solid area was evaluated. The liquid developer and the printed image were stored in a laboratory (an illumination of 730 lux was provided for 14 hours a day) at normal temperature of 25° C. and normal humidity of 50%. The liquid developer was placed in a beaker and stored uncovered. For the comparison, a liquid developer to which an antioxidant was not added was prepared and used as a blank.

TABLE 9

| | Initial stage | | After 6 months | |
|---|---|---|---|---|
| | | Example | | Example |
| | Blank | 7-1 | Blank | 7-2 |
| Dispersibility of liquid | Good | Good | Separated | Good |
| developer | | | into solid | |
| | | | and liquid | |
| 4 point Text | Legible | Legible | Illegible | Legible |
| Fixing ratio in solid area | 83% | 84% | 93% | 98% |

### Example 8

The same procedure as in Example 7 was carried out except that diphenyl monodecyl phosphite (a transparent liquid, molecular weight: 374) was used instead of trilauryl phosphite used in Example 7.

The results are shown in Table 10.

TABLE 10

| | Initial stage | | After 6 months | |
|---|---|---|---|---|
| | | Example | | Example |
| | Blank | 8-1 | Blank | 8-2 |
| Dispersibility of liquid | Good | Good | Separated | Good |
| developer | | | into solid | |
| | | | and liquid | |
| 4 point Text | Legible | Legible | Illegible | Legible |
| Fixing ratio in solid area | 81% | 86% | 93% | 97% |

### Example 9

The same procedure as in Example 7 was carried out except that 0.438 g of trilauryl phosphite and 0.438 g of diphenyl monodecyl phosphite were used instead of 0.875 g of trilauryl phosphite used in Example 7.

The results are shown in Table 11.

TABLE 11

| | Initial stage | | After 6 months | |
|---|---|---|---|---|
| | | Example | | Example |
| | Blank | 9-1 | Blank | 9-2 |
| Dispersibility of liquid | Good | Good | Separated | Good |
| developer | | | into solid | |
| | | | and liquid | |
| 4 point Text | Legible | Legible | Illegible | Legible |
| Fixing ratio in solid area | 83% | 84% | 93% | 98% |

The storage stability of the liquid developer according to the embodiment of the invention to which trilauryl phosphite and/or diphenyl monodecyl phosphite were/was added was extremely favorable, and a 4 point text obtained by using the liquid developer after 6 month storage was legible. However, the liquid developer to which a trilalkyl phosphite and/or a diphenyl alkyl phosphite were/was not added was separated into a solid and a liquid after 6-month storage. The liquid developer separated into a solid and a liquid was stirred and then introduced into a developing section of the image forming apparatus and reproduction of printed image was attempted. However, precipitation of solid matter was observed, the quality of the reproduced print was worse than that in the initial stage, and it was difficult to read the 4 point text.

Since oxidative polymerization of corn oil which is a carrier liquid proceeds during storage of the liquid developer, the fixing ratio in a solid area in an image formed with a liquid developer containing corn oil is improved over time. However, the improvement of the fixing ratio in the solid area in the image formed with the liquid developer to which a trilalkyl phosphite and/or a diphenyl alkyl phosphite were/was not added was smaller than that of the case where the liquid developer according to the embodiment of the invention to which trilauryl phosphite and/or diphenyl monodecyl phosphite were/was added was used.

The reason is presumed to be that oxidatively polymerized corn oil was decomposed in the liquid developer to which a trilalkyl phosphite and/or a diphenyl alkyl phosphite were/was not added.

What is claimed is:

1. A liquid developer comprising:
a vegetable oil as a carrier liquid;
a positively chargeable pigment; and
an antioxidant including a trialkyl phosphite represented by the chemical formula 1 and/or a diphenyl alkyl phosphate represented by the chemical formula 2:
(CₘH₂ₘ₊₁O)₃P Chemical formula 1
wherein m is 2 to 20, 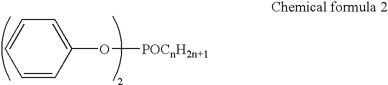
wherein n is 5 to 15.

2. The liquid developer according to claim 1, wherein the vegetable oil includes at least one member selected from the group consisting of flaxseed oil, MO sunflower oil, rapeseed oil, divider oil, HOLL canola, thistle saffron oil, olive oil, peanut oil, sesame oil, corn oil, soybean oil, cotton seed oil and safflower oil.

3. The liquid developer according to claim 1, wherein the trialkyl phosphite and/or the diphenyl alkyl phosphite are/is soluble in the vegetable oil.

4. The liquid developer according to claim 1, wherein the added amount of the trialkyl phosphite and/or the diphenyl alkyl phosphite is 0.01 to 5.0% by mass based on the total amount of the vegetable oil and the positively chargeable pigment.

5. The liquid developer according to claim 1, wherein the trialkyl phosphite is triethyl phosphite, tris(2-ethylhexyl)phosphite, tridecyl phosphite, trilauryl phosphite or tris(tridecyl)phosphite.

6. The liquid developer according to claim 1, wherein the diphenyl alkyl phosphite includes at least one member selected from the group consisting of diphenyl mono(2-ethylhexyl)phosphite, diphenyl monodecyl phosphite and diphenyl mono(tridecyl)phosphite.

7. An image forming apparatus which uses a liquid developer including:
a vegetable oil as a carrier liquid;
a positively chargeable pigment; and
an antioxidant including a trialkyl phosphite represented by the chemical formula 1 and/or a diphenyl alkyl phosphite represented by the chemical formula 2:
(CₘH₂ₘ₊₁O)₃P Chemical formula 1
wherein m is 2 to 20, 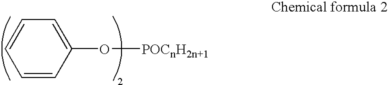
wherein n is 5 to 15.

8. The image forming apparatus according to claim 7, comprising:
a photoreceptor on which an electrostatic latent image is formed; and
a transfer unit,
wherein the electrostatic latent image on the photoreceptor is transferred to a recording medium passing through between the photoreceptor and the transfer unit.

9. The image forming apparatus according to claim 7, comprising:
a photoreceptor on which an electrostatic latent image is formed;
an intermediate transfer unit, which is an endless belt supported in a tensioned state by rollers; and
a secondary transfer unit which secondarily transfers an image on the intermediate transfer unit, which is formed by primarily transferring an electrostatic latent image on the photoreceptor to the intermediate transfer unit from the photoreceptor, to a recording medium.
